(19) United States
(12) Patent Application Publication
(10) Pub. No.: US 2013/0329448 A1
(43) Pub. Date: Dec. 12, 2013

(54) LIGHTING APPARATUS WITH PHOSPHOR ELEMENT

(71) Applicants: Kai Franz, Regensburg (DE); Ulrich Hartwig, Berlin (DE)

(72) Inventors: Kai Franz, Regensburg (DE); Ulrich Hartwig, Berlin (DE)

(73) Assignee: OSRAM GMBH, Muenchen (DE)

(21) Appl. No.: 14/000,908

(22) PCT Filed: Mar. 1, 2011
(86) PCT No.: PCT/EP11/53014

§ 371 Date: Aug. 22, 2013

(51) Int. Cl. F21V 13/02

(52) U.S. Cl. CPC F21V 13/02
USPC 362/555; 362/231

(57) ABSTRACT

A lighting apparatus includes an exciting light source for emitting exciting light; a phosphor element having a phosphor for converting at least partially the exciting light into yellow light; a solid state light source for emitting blue light; and an optical system for guiding the exciting light onto the phosphor element and guiding and mixing the converted yellow light and the blue light. The optical system includes a dichroic mirror for reflecting blue light and transmitting yellow light.

### RELATED APPLICATIONS

The present application is a national stage entry according to 35 U.S.C. §371 of PCT application No.: PCT/EP2011/053014 filed on Mar. 1, 2011.

### TECHNICAL FIELD

Various embodiments relate to a lighting apparatus comprising a phosphor element for converting exciting light into converted light.

### BACKGROUND

For numerous lighting applications utilizing light guides, in particular for endoscopy, microscopy and medical headlamps, light sources with high colour rendering index (CRI) and high lumen output as well as high brightness are necessary. Traditionally, Xenon short-arc discharge lamps (e.g. OSRAM XBO®) with power input of several 100 W, embedded in optical reflectors, have been used. Due to the relatively high input power, limited lifetime with shifting luminous properties and adverse thermal impact on illuminated targets, there has been growing demand for alternative, more energy efficient light sources. Solid state light sources such as light emitting diodes (LED) are becoming increasingly popular for general lighting applications. However, white LEDs do still not provide the high lumen output and brightness needed for special lighting applications.

U.S. Pat. No. 7,494,228 B2 discloses a light generating system for mixing different light colours from different LEDs or energized phosphors. FIG. 7 shows a system comprising an array of blue or UV LEDs 76 energizing a green phosphor 74 through a dichroic mirror 82. The converted green light is reflected by the dichroic mirror into a mixing tunnel 90. Furthermore, blue light emitted by an array of blue LEDs 92 and red light emitted by an array of red LEDs 98 are reflected by respective dichroic mirrors 96, 102 into the mixing tunnel 90. Accordingly, the green light, blue light and red light are mixed in the mixing tunnel 90 and directed to the output port 104 of the mixing tunnel 90. The output port opening is matched to a light guide 52.

### SUMMARY

Various embodiments provide a lighting apparatus, based on at least one solid state light source, suitable for lighting applications that require white light of high brightness. Various embodiments also provide a solid state lighting apparatus suitable for technical and medical light guide applications.

Various embodiments provide a lighting apparatus including: an exciting light source for emitting exciting light; a phosphor element including a phosphor for converting at least partially the exciting light into yellow light; a solid state light source for emitting blue light; an optical system for guiding the exciting light onto the phosphor element and guiding and mixing the converted yellow light and the blue light.

According to the disclosure, converted yellow light, emitted by a phosphor layer when excited by exciting light, is mixed with blue light, emitted by at least one solid state light source, e.g. a laser diode or a light emitting diode (LED) such as a blue high-power multi-chip LED, resulting in white light.

In the context of the disclosure the term phosphor means any wavelength-converting substance such as a fluorescent or phosphorescent material. Furthermore, the phosphor may also comprise more than one phosphor component, i.e. may be a mixture of two or more phosphor components.

To achieve lumen output as high as possible, the exciting light source may comprise at least one laser light source, preferably a laser diode, a laser diode stack or an array of laser diodes. In the case of multiple laser light sources, each one may emit laser light having the same specific centre wavelength (for example 450 nm, 445 nm or 405 nm), i.e. all of the laser light sources are of the same type. Alternatively, the exciting light may comprise a mixture of different centre wavelengths, i.e. multiple laser light sources of different type may be used.

Depending on the type of phosphor used, the exciting light may be blue or violet or even ultraviolet light being converted to yellow light, i.e. light of longer wavelength (“down-converting”). According to a preferred embodiment, an array of laser diodes emits exciting light with wavelength of about 450 nm (blue light). The blue laser light is at least partially wavelength-converted by a suitable phosphor, e.g. YAG:Ce or (Y_{0.96}Ce_{0.04})₃Al_{3.75}Ga_{1.25}O₁₂, to yellow light having a broad spectral distribution with a peak at approximately 570 nm. Any other suitable phosphor emitting yellow light may be used or even a mixture of two or more phosphor components, which as a whole emits yellow light. The wavelength-converted yellow light is mixed with blue LED light, e.g. with a wavelength of approximately 470 nm, resulting in white light.

The luminous properties, particularly the CRI, of the mixed light emanating from the lighting apparatus may be further improved by adding red and/or green light to the yellow and blue light. For this purpose the lighting apparatus may further comprise a red and/or green light emitting LED and/or a supplemental phosphor element comprising a red light emitting phosphor, e.g. (Sr, Ba, Ca)₂Si₅N₈ or CaAlSiN₂:Eu, and/or green light emitting phosphor, e.g. (Ba_{0.40}Eu_{0.60}Mn_{0.30})MgAl₁₀O₁₇. The supplemental red and/or green light emitting phosphors may be mixed with the yellow light emitting phosphor for emitting a converted mixed light, comprising yellow and red and/or green light. Finally, the converted mixed light is mixed with the blue light, emitted by the at least one solid state light source, resulting in mixed white light with improved CRI.

Preferably, pre-adjusted values of the corresponding colour temperature (CCT), e.g. 5000 or 6000 K, and colour rendering index (CRI), e.g. min. 60, preferred min. 70, more preferred min. 80, of the mixed white light may be achieved by adjusting and controlling the respective output powers of the exciting light source and the at least one blue LED. According to a preferred embodiment, the phosphor element comprises a carrier member having a front face, whereby the phosphor is arranged on the front face of the carrier member, e.g. as a phosphor layer. Advantageously, the carrier member is made from a material with suitable cooling properties, e.g. a metal such as copper, aluminium or the like, facilitating dissipation of the heat generated by the exciting light when impinging on the phosphor layer. For further improved cooling the phosphor element may also be arranged on a rotating device. If the carrier member comprises a solid body, the wavelength-converted light is reflected off the phosphor element and collected and mixed by an optical system (“reflective mode”). However, the carrier member may also comprise a light-transmissive sheet for transmitting the wavelength-converted light (“transmissive mode”).

The optical system may comprise a dichroic mirror, having a rear side and a front side, each of which, for example, may comprise interference layers. The rear side is adapted for reflecting the exciting light onto the phosphor element and transmitting the converted yellow light emerging from the phosphor element. The front side is adapted for reflecting the blue LED light and transmitting the converted yellow light. Therefore, the converted yellow light is transmitted by the dichroic mirror, but the exciting light is blocked. This is particularly advantageous when using laser light for exciting the phosphor, because the resulting mixed white light is laser-light-free, which may be relevant for certain applications, particularly medical applications. Preferably, all the elements of the lighting apparatus are arranged and adjusted in such a way that the transmitted yellow light and the reflected blue LED light exit the lighting apparatus in the same direction, resulting in mixed white light, for further utilization, e.g. coupling into a light guide such as a glass fibre.

The optical system may further comprise a first optical element, arranged in front of the phosphor element, for guiding the exciting light onto the phosphor layer. This may help to avoid hot-spots on the phosphor layer, particularly when using high power laser light for exciting the phosphor. The converted yellow light is collected and guided by the first optical element in the direction of the rear side of the dichroic mirror. Furthermore, a second optical element may be arranged in front of the blue LED for guiding the blue LED light in the direction of the front side of the dichroic mirror. Each of the optical elements may be elongated and designed to transmit light by way of total internal reflection (TIR) along its longitudinal axis.

Further optical elements, e.g. collimating lenses, may be beneficial for shaping the various light beams of the lighting apparatus. Further details will be explained in the description of the drawing.

Furthermore, two or more mixed white light beams, each emanating from separate lighting apparatus according to the disclosure, may be mixed in a modular manner to enhance lumen output.

### BRIEF DESCRIPTION OF THE DRAWING

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic top view of an embodiment of lighting apparatus according to the disclosure.

### DETAILED DESCRIPTION

The following detailed description refers to the accompanying drawings that show, by way of illustration, specific details and embodiments in which the invention may be practiced.

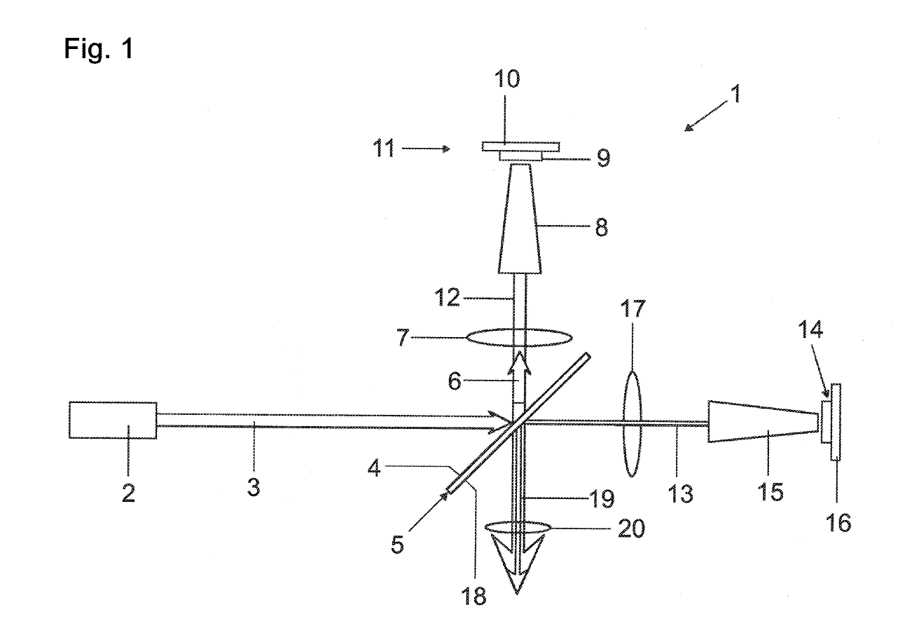

FIG. 1 schematically shows a preferred embodiment of a lighting apparatus 1 according to the disclosure, designed for substituting a 300 W Xenon lamp in lighting applications such as endoscopy, microscopy and medical headlamps.

A laser diode array 2, comprising 6 times 7 individual blue laser diodes (not shown), delivers a total laser output power of approximately 42 W. The blue laser beam 3, comprising 42 individual laser beams (not shown), which are arranged to form a 6 times 7 matrix array of laser beams, is being reflected by the rear side 4 of a dichroic mirror 5. For this purpose the rear side 4 of the dichroic mirror 5 comprises an interference coating for reflecting blue light, but transmitting yellow light. The dichroic mirror 5 is tilted such that the angle of incidence of the incident blue collective laser beam 3 is approximately 45°. Therefore, the angle between the incident collective laser beam 3 and the reflected collective laser beam 6 is approximately 90°. The reflected collective laser beam 6 passes a lens 7, which focuses the 42 individual laser beams on the 4 mm² entrance of a first TIR-optic 8. The first TIR-optic 8 guides the individual laser beams onto a phosphor layer 9 by virtue of total internal reflection, thus avoiding hot-spots on the phosphor layer 9. The TIR-optic 8 is of elongated and tapered shape, whereby the smaller end of the TIR-optic 8 faces the phosphor layer 9. The phosphor layer 9 is coated on a carrier member 10, constituting a phosphor element 11. The carrier member 10 is made of aluminium, because of its proper thermal properties. The phosphor layer 9 has a thickness of approximately 40 μm and consists of the yellow light emitting phosphor (Y_{0.96}Ce_{0.04})₃Al_{3.75}Ga_{1.25}O₁₂. The phosphor layer 9 converts almost all (more than 95%) of the impinging blue collective laser beam 6 to yellow light, the latter of which is collected and guided by the TIR-optic 8. Beyond the TIR-optic 8 the yellow light beam 12 passes through and is being parallelized by the lens 7, thereby avoiding unacceptable deviations from the designated incidence angle of the dichroic mirror 5 and, hence, ensuring maximal transmission through its interference coating. The small unconverted remainder of the blue laser beam 6, which is scattered back is blocked by the rear side 4 of the dichroic mirror 5, thus avoiding risk to the human eye. Furthermore, a blue light beam 13, emerging from a blue LED 14 (LE B Q6WP from the company OSRAM Opto Semiconductor), is guided through a second TIR-optic 15, which is similar to the first one. The blue LED 14 is mounted on a cooling plate 16. After passing through and being parallelized by a second lens 17 the blue light beam 13 is reflected by the front side 18 of the dichroic mirror 5. For this purpose the front side 18 of the dichroic mirror 5 comprises an interference coating for transmitting the yellow light beam 12, but refleeting the blue LED light 13. The LED light branch, comprising the blue LED 14, the second TIR-optic 15 and the second lens 17, is aligned with respect to the tilted dichroic mirror 5 such that the blue light beam 13 is reflected in the direction of the transmitted yellow light beam 12, resulting in a mixed white light beam 19. The mixed white light beam 19 is focused on the entrance aperture of a light guide (not shown) via a third lens 20. The lumen output achieved with the lighting apparatus 1 is approximately 2,600 lm.

Furthermore, means for adjusting and controlling the respective output powers of the laser diode array 2 and the blue LED 14 may be provided (not shown) for adjusting and controlling the corresponding colour temperature (CCT) and colour rendering index (CRI) of the mixed white light beam. To this end, sensor elements (not shown) may be arranged for detecting light scattered from both TIR-optics. The signals of the sensors may be used for adjusting the input power of the laser diode array 2 and the blue LED 14, respectively.

While the disclosed embodiments has been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A lighting apparatus comprising:
an exciting light source for emitting exciting light;
a phosphor element comprising a phosphor for converting the exciting light at least partially into yellow light;
a solid state light source for emitting blue light; and
an optical system for guiding the exciting light onto the phosphor element and guiding and mixing the converted yellow light and the blue light.

2. The lighting apparatus according to claim 1, wherein the optical system comprises a dichroic mirror having a rear side and a front side, the rear side being adapted for reflecting the exciting light onto the phosphor element and transmitting the converted yellow light emerging from the phosphor element, the front side being adapted for reflecting the blue light emanating from the solid state light source and transmitting the converted yellow light.

3. The lighting apparatus according to claim 2, wherein the optical system further comprises a first optical element, arranged in front of the phosphor element, for guiding the exciting light onto the phosphor element and collecting and guiding the converted yellow light in the direction of the rear side of the dichroic mirror.

4. The lighting apparatus according to claim 2, wherein the optical system further comprises a second optical element, arranged in front of the solid state light source, for guiding the blue light, emanating from the solid state light source, in the direction of the front side of the dichroic mirror.

5. The lighting apparatus according to claim 3, wherein the optical element is elongated and designed to transmit light by way of total internal reflection along its longitudinal axis.

6. The lighting apparatus according to claim 1, wherein the phosphor of the phosphor element comprises (Y_{0.96}Ce_{0.04})₃Al_{3.75}Ga_{1.25}O₁₂.

7. The lighting apparatus according to claim 1, wherein the phosphor of the phosphor element further comprises a red and green light emitting phosphor.

8. The lighting apparatus according to claim 1, wherein the exciting light is blue light.

9. The lighting apparatus according to claim 1, wherein the exciting light source comprises a laser light source.

10. The lighting apparatus according to claim 1, wherein the solid state light source comprises a blue light emitting diode.

11. The lighting apparatus according to claim 1, wherein the phosphor element comprises a carrier member having a front face, whereby the phosphor is arranged on the front face of the carrier member.

12. The lighting apparatus according to claim 11, wherein the carrier member comprises a rotating device.

13. The lighting apparatus according to claim 1, further comprising a control system for achieving a pre-adjusted CRI by controlling and adjusting the respective output powers of the exciting light source and the solid state light source.

14. The lighting apparatus according to claim 3, wherein the optical system further comprises a second optical element, arranged in front of the solid state light source, for guiding the blue light, emanating from the solid state light source, in the direction of the front side of the dichroic mirror.

15. The lighting apparatus according to claim 4, wherein the optical element is elongated and designed to transmit light by way of total internal reflection along its longitudinal axis.

16. The lighting apparatus according to claim 9, wherein the laser light source is a laser diode, a laser diode bulk or a laser diode array.
